(19) United States
(12) Patent Application Publication
(10) Pub. No.: US 2010/0083219 A1
(43) Pub. Date: Apr. 1, 2010

(54) Runtime Object Composition

(75) Inventors: Christopher Tavares, Issaquah, WA (US); Michael Puleio, Duyall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/243,495

(22) Filed: Oct. 1, 2008

(51) Int. Cl. G06F 9/44

(52) U.S. Cl. 717/107

(57) ABSTRACT

Objects in computing environments are often instantiated based on a class definition that is statically declared at design time, but such instantiation limits the flexibility of the objects so created. Objects may also be composed at runtime through a series of invocations of a reflection programming interface, but reflection techniques may be computationally expensive, and the generation of many objects at runtime based on a single object definition may redundantly invoke the reflection programming interface. As provided herein, when requested to generate a new object at runtime based on an object definition, the host environment may instead automatically generate a factory method (via reflection) using the object definition, and may invoke the factory method to compose the object. The factory method may also be cached with the object definition to facilitate the composing of additional objects based on the same object definition, thereby economizing computing resources and improving system performance.

### BACKGROUND

In many computing environments, an object comprises a set of members, such as primitive data types (e.g., integers and strings), constants, methods (including constructors and destructors), contained member objects, interfaces, and attributes. An application may involve a large number and variety of such objects that interoperate and utilize various system resources in furtherance of the application.

Objects are often instantiated based on a class that this statically declared at design time, such that the environment hosting the object may allocate and instantiate the memory occupied by the object based on the definition of the class. Such objects often contain one or more constructor methods, which the object hosting environment automatically invokes to facilitate the instantiation of the members of the object. In this manner, a new object may be added to the application based on the definition of the class specified during the design of the application.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the instantiation of an object may be based on a class definition that is statically declared at runtime, some scenarios may benefit from dynamically choosing which class to instantiate and which parameters to use to create an instance of the object. A running application may receive (e.g., from a user or another automated process) an object definition that describes the structure and members of an object, and the application may be tasked with composing and instantiating the object based on the definition. The hosting environment may have access to runtime-based object composing tools, such as a reflection library, and might endeavor to compose the object through a series of invocations of such object composing tools. However, such tools are often slow and/or resource-intensive, because respective invocations of the tools involve a series of safeguards against the object and the requested operation to promote consistent operation and to protect the integrity of the hosting environment. Moreover, if several objects are composed based on a particular object definition, the same safeguards are often evaluated for each object, further diminishing the speed and available resources of the hosting environment.

As provided herein, an alternative technique for composing an object at runtime based on an object definition (such as a class definition) involves an automated generation of a factory method. Upon receiving a request to compose an object according to a particular object definition, the hosting environment may instead author a method that composes the object, and may then execute this method to compose the object. This alternative technique may be faster than the use of runtime-based object composing tools, because the safety checked are performed upon generation of the factory method, not upon each invocation of a composing tool during the composing of the object. Moreover, if additional objects are to be composed based on the same object definition, the previously generated factory method may be invoked again. The reuse of the factory method may enable avoiding the redundant evaluation of safeguards during the composition of additional objects and further improving the performance and economizing the resources of the hosting environment.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an exemplary class definition that may be statically declared at design time.

FIG. 2 is an illustration of an exemplary scenario featuring an instantiation of an object at runtime based on the class definition statically declared at design time illustrated in FIG. 1.

FIG. 3 is an illustration of an exemplary scenario featuring a composing of an object at runtime through a series of invocations of a reflection programming interface.

FIG. 4 is an illustration of an exemplary scenario featuring a composing of an object at runtime through an automatic generation and invocation of a factory method.

FIG. 5 is a flow chart illustrating an exemplary computer-implemented method of composing an object at runtime according to an object definition.

FIG. 6 is an illustration of an exemplary scenario featuring a generating of a factory method at runtime through a compiler.

FIG. 7 is an illustration of an exemplary scenario featuring an emitting of a factory method at runtime through a reflection emit method.

FIG. 8 is an illustration of an exemplary caching of a factory method with an object definition in a factory method cache.

FIG. 9 is an illustration of an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Many computing environment scenarios involve the use of an object, which is a data container instantiated at runtime as part of an application. An object may contain zero or more members, such as primitive data types (e.g., integers and strings), declared constants, methods (including constructors and destructors), contained member objects, interfaces, and attributes.

In many scenarios, an object may be declared in a source code, such as a method that calls for the instantiation of an object to store a particular kind of data or to perform a particular task. The source code often specifies that one or more objects are to be composed based on the design of a particular class, which may also be declared in the source code or in an external library, and which may indicate a set of members that comprise instances of the class. The source code may be compiled and executed, and the system hosting the executable may (during runtime) instantiate objects according to the definition of the class, e.g., by allocating a suitable block of memory for the new object and initializing the value of the portions of memory corresponding to the members of the object. The source code may also invoke one or more constructor methods associated with the object that facilitate the initialization of the object (e.g., by subscribing event handler functions to events that may arise within the computing environment.) In this manner, the source code may direct the instantiation of a potentially large and varied set of objects in furtherance of the tasks handled by the application.

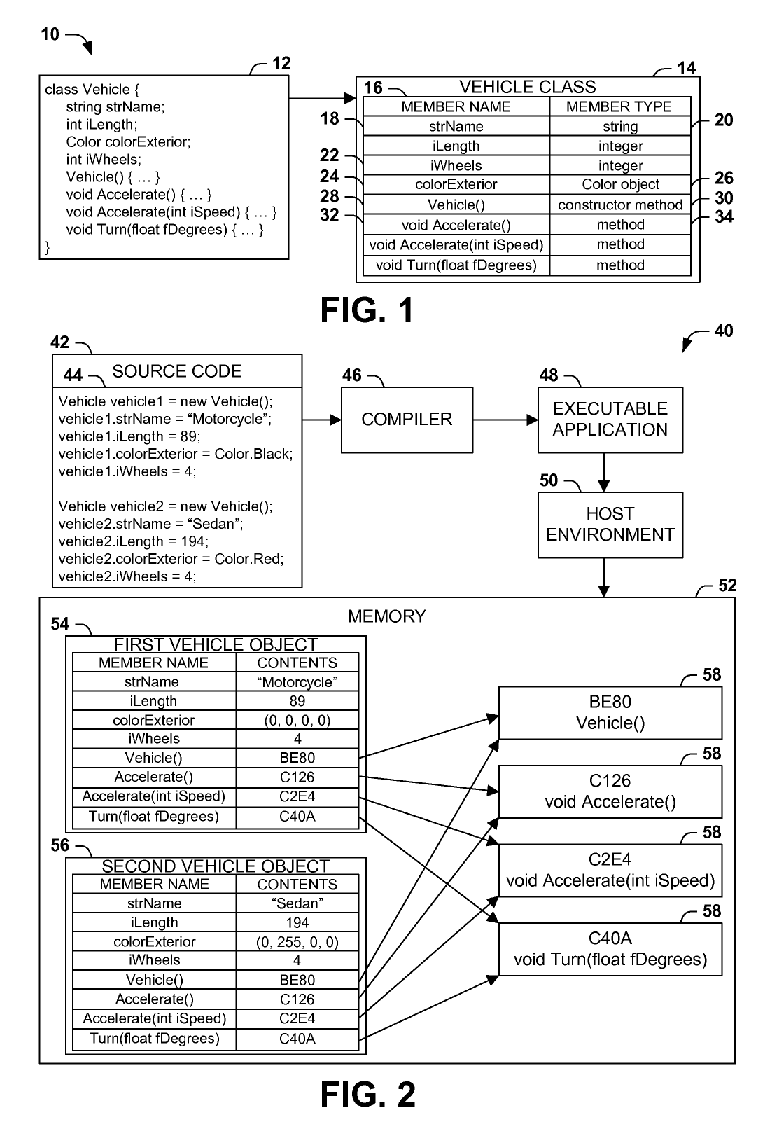

FIGS. 1-2 together illustrate a generation of an object based on a class definition that is statically specified at design time. FIG. 1 illustrates an exemplary scenario 10 involving a pseudocode block 12 featuring a definition of a class. It may be appreciated that this pseudocode block 12 (and each of the other pseudocode blocks illustrated and discussed herein) is presented in a pseudocode language that may not conform to the syntactic and logical constraints of any particular programming or mathematical language. Rather, these pseudocode blocks are presented to illustrate some concepts that may be implemented through instructions configured in a logically similar manner. The exemplary pseudocode block 12 of FIG. 1 features a definition of a Vehicle class, from which objects may be instantiated at runtime to represent various vehicles. The pseudocode block 12 may result in the logical generation of a Vehicle class 14 that defines various members contained within objects instantiated therefrom, including primitive objects (such as a first member 18 defined as a string type 20), contained objects (such as a second member 24 defined as a Color object 26 contained within Vehicle objects instantiated from the Vehicle class 14), and references to methods that may represent constructors (such as the Vehicle( ) member 28 defined as a constructor method 30) or invokable methods (such as the Accelerate( ) member 32 defined as an invokable method 34.)

Based on the Vehicle class 14 defined in the pseudocode block 12 of FIG. 1, objects may be generated as instances of the Vehicle class 14. For example, a source code 42 may include the instructions included in the pseudocode block 44 of FIG. 2 that specify an instantiation of two instances of the Vehicle class 14 as a first vehicle object 54 (named “vehicle1” in the pseudocode block 44) and a second vehicle object 56 (named “vehicle2” in the pseudocode block 44.) Although these instances of the Vehicle class 14 are specified in the source code 42 at design time, the objects are not yet composed. The source code 42 is first compiled by a compiler 46 to produce an executable application 48, comprising partially or wholly compiled instructions. The executable application 48 may later be executed within a host environment 50 (such as an operating system, or a runtime provided therein that provides resources to the executable application 48 while managing its execution to promote safe operation.)

At runtime, the host environment 50 may encounter the instructions specified in the pseudocode block 44 that call for the instantiation of the objects. The host environment 50 may therefore interact with the memory 52 of the computer system to allocate and initialize two blocks of memory representing two instances of the Vehicle class 14. Memory may be allocated for the first vehicle object 54, and the fields of the first vehicle object 54 may then be instantiated (as specified in the pseudocode block 44) to produce an object representing a particular motorcycle. Memory may also be allocated for the second vehicle object 56, and the fields of the second vehicle object 56 may then be instantiated (as specified in the pseudocode block 44) to produce an object representing a particular type of sedan automobile. The method members of these objects may also be associated with compiled methods 58 that are stored in the memory 52, e.g., by setting the method fields of the objects to the addresses of the associated methods. Thus, the host environment 50 fulfills the instructions expressed in the pseudocode block 44 of the source code 42 to generate two objects structured according to the definition of the Vehicle class 14. It may be appreciated that, although the details of the objects are fully specified at design time, the objects are not composed until runtime.

The composing of objects based on a class definition specified at design time (such as illustrated in the exemplary scenarios of FIGS. 1-2) may suffice in many computing scenarios. However, in other computing scenarios, an object may be instantiated at runtime based not on a class definition that is statically defined at design time, but according to an object definition that is provided at runtime. As a first example, the application may allow a user to customize an object by adding an arbitrary set of members of various user-selected types. As a second example, the application may serve a broad set of client applications that submit a large variety of requests, or may expose a portion of the application for customizable interfacing with other client applications (e.g., by offering a pluggable interface), and the application may be robustly designed to compose a large variety of objects that correspond to such various interactions. In such scenarios, the source code cannot specify a full instantiation of such objects based on the set of classes available at design-time; instead, the application is configured to enable the instantiation of objects based on object definitions provided at runtime.

One technique for permitting-the instantiation of an object based on an object definition provided at runtime involves the use of runtime object composition tools, such as reflection tools. These tools permit an executing application to examine the details of an object, such as its type, attributes, and members, and to compose objects as sets of members. Such tools are occasionally provided as part of the hosting environment of the application (e.g., as a runtime included in the servicing of the application), and the application may invoke them to achieve the composing of the object in an arbitrary, incremental manner during runtime.

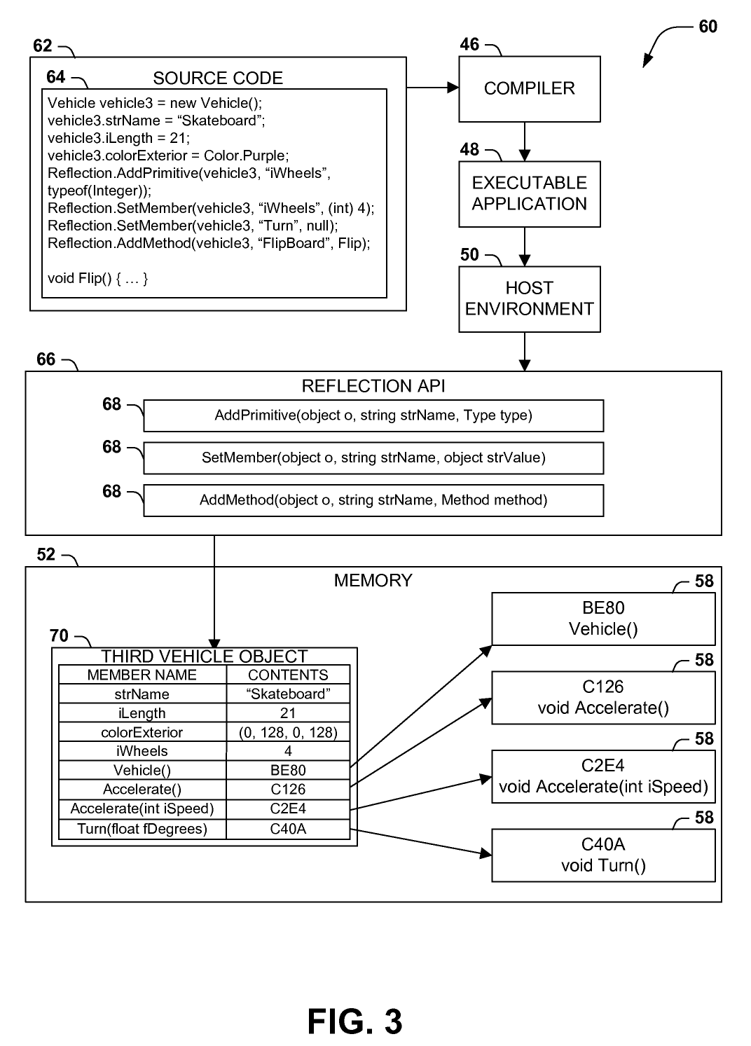

FIG. 3 illustrates an exemplary scenario 60 involving a dynamic generation of an object based on a set of invocations of a reflection programming interface 66. The exemplary scenario 60 involves a source code 62 containing a pseudocode block 64 that specifies an instantiation of an object based on the Vehicle class 14 that represents a particular skateboard. However, the pseudocode block 64 also specifies some operations through the reflection programming interface 66 for altering the composition of the object, such as by instantiating a particular type of the object (e.g., a particular subclass of the object) setting a particular field to a particular value. (Although the specification of this object may be fully understood from the pseudocode block 64, the source code 62 might alternatively accept a data file provided at runtime, such as an XML file, and might parse the data file into operations through the reflection programming interface 66. It may be appreciated that the structure of an object generated in this manner might not be fully specified until runtime.)

The source code 62 may be compiled by a compiler 46 to produce an executable application 48 that may be executed by a host environment 50, which is capable of invoking the reflection programming interface 66 in order to service the executable application 48. At runtime, the host environment 50 encounters the instructions within the pseudocode block 64 of the source code 62, and instantiates a third vehicle object 70 structured according to the Vehicle class 14, e.g., by instantiating a particular subclass of the Vehicle class and setting some member variables of the third vehicle object 70. The host environment 50 also utilizes the reflection programming interface 66 to alter the third vehicle object 70, via a series of invocations of reflection methods 68, such as a “SetMember” reflection method that may be invoked to set the value of a member of the third vehicle object 70 (such as a primitive type or a reference to a method or object.) Though this series of invocations of the reflection programming interface 66, the host environment 50 thereby achieves the instantiation of the third vehicle object 70 as specified in the pseudocode block 64.

However, the creative power of reflection tools often entails a computing expense in the form of a significant number of safeguards to verify that such tools are being used in a consistent manner that does not compromise the integrity of the computing environment. For example, when a method of a statically declared object is invoked with a set of parameters, the number and types of the provided parameters may be compared with the signature of the invoked method during compiling to verify that the method is being properly invoked; if successful, this check may be omitted at runtime. However, if a reflection library is used to pass a set of parameters to a named method of an object, the hosting environment first identifies the method having the identified name (which may be difficult if the method name is overloaded, i.e., if multiple methods of the object share the name), and then verifies the number and types of the parameters. These checks are performed at runtime, which consumes computing resources and significantly diminishes the performance of the application. Similarly, composing an object through a series of invocations of object compositing tools involves an evaluation of a series of safeguards during each invocation. For example, in the exemplary scenario 60 of FIG. 3, the respective invocations of the reflection methods 68 of the reflection programming interface 66 typically examine the object and the requested alteration of the object for validity. Moreover, if multiple objects are to be composed based on a particular object definition, the hosting environment performs the series of checks for each new object. For example, in the exemplary scenario 60 of FIG. 3, if the source code 62 specified the instantiation of an additional Vehicle object representing another skateboard object, the same set of safeguards would be redundantly evaluated by the invoked reflection methods 68 of the reflection programming interface 66. As a result, this manner of composing an object (or a series of such objects) based on an object definition provided at runtime may be computationally expensive.

An alternative technique may be devised for composing objects based on object definitions provided at runtime that reduces the expense and the redundant evaluation of safeguards. The alternative technique involves the generation of the object through the use of an automatically generated factory method. For example, upon receiving a request to generate an object at runtime, the computer system may examine the object definition and may generate a factory method that, when invoked, generates an object with the desired structure. The computer system may then invoke the factory method to generate the requested object. In contrast with a series of invocations of object composing tools (such as a reflection programming interface), the computer system may evaluate all of the safeguards relating to object generation while parsing the object definition and generating the factory method. Thus, the safeguards are effectively consolidated into a more comprehensive review of the object definition, and the resulting factory method may be safely invoked to generate the object without relying on the already evaluated safeguards, thereby improving the performance of the computing environment as contrasted with a serial reliance on object composing tools. Moreover, the compiled factory method may be stored, and if additional objects of the same type are requested, the computer system may retrieve the stored factory method and invoke it to generate a second object according to the object definition provided at runtime, thereby avoiding many or all of the safeguards imposed on the generation of every runtime-defined object, as may be involved in the serial invocation of object composing tools.

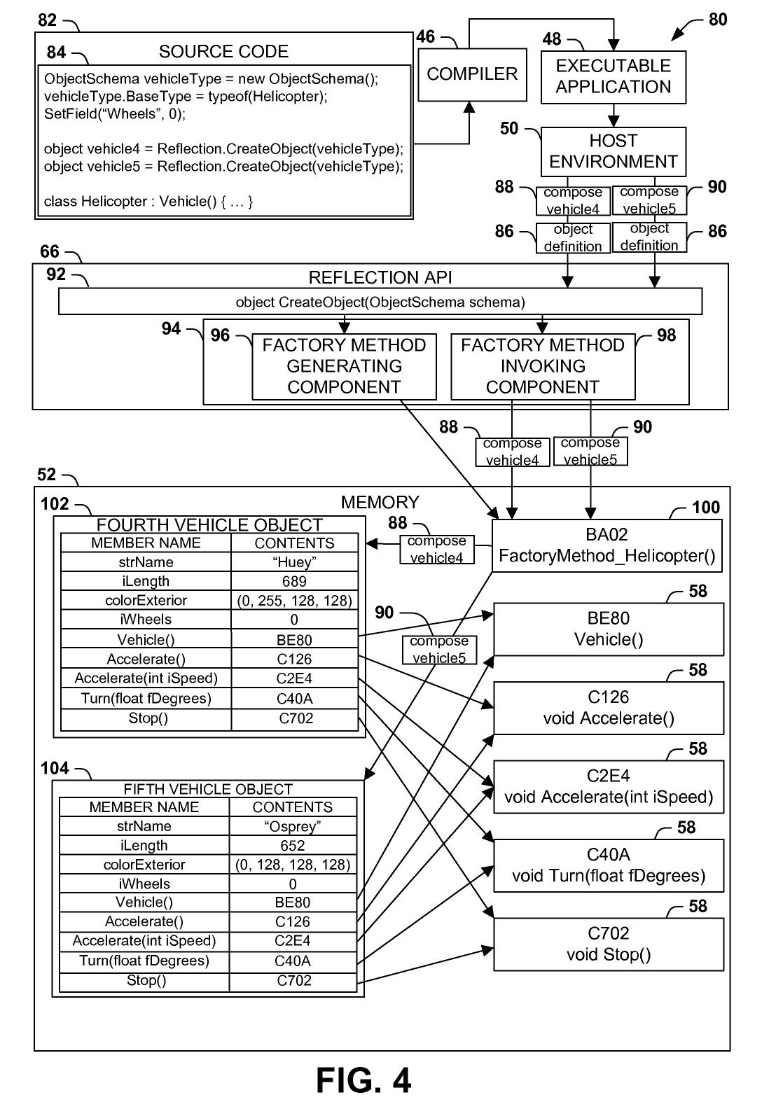

FIG. 4 illustrates an exemplary scenario 80 including the application of this alternative technique to handle the generation of an object based on an object definition 86 provided at runtime. More specifically, FIG. 4 illustrates an exemplary embodiment of this technique, comprising a system 94 configured to compose an object at runtime according to an object definition. The system 94 comprises a factory method generating component 96 configured to generate a factory method that composes the object according to the object definition, and a factory method invoking component 98 configured to invoke the factory method to compose the object. Together, these components may be included in a computer system (such as within a reflection programming interface 66, and/or within a host environment 50, such as a runtime) to facilitate the composing of objects based on object definitions 86 provided at runtime.

The exemplary scenario 80 involves source code 82 including a pseudocode block 84 that specifies the composing of two objects representing two helicopters. The pseudocode block 84 specifies an object definition 86 to be used for composing both objects, where the object definition 86 derives from the Vehicle class 14 but adjusts the representation in furtherance of the representation of a helicopter. For example, the pseudocode block 84 specifies that this particular object is to be derived from the Helicopter subclass of the Vehicle class, and that the field representing the number of wheels is to be set to zero. Having prepared an object definition 86, the pseudocode block 84 then invokes a reflection programming interface 66 to compose two objects based on the object definition 86. (Again, it may be appreciated that while the pseudocode block 84 of FIG. 4 fully specifies the composition of these objects at design time, the same method might alternatively accept a data file provided at runtime, such as an XML file, and might parse the data file into an object definition 86 to be applied through the reflection programming interface 66. The object definition 86 generated in this manner might not be fully specified until runtime.)

The source code 82 may be compiled by a compiler 46 into an executable application 48, which may be executed by and within a host environment 50. In performing the instructions expressed in the pseudocode block 84, the host environment 50 may generate an object definition 86 (the “vehicleType” object.) This object definition 86 may then be delivered to a reflection method 92 within the reflection programming interface 66 during two requests to compose the objects: a first object composing request 88 and a second object composing request 90. It may be noted that the host environment 50 in this exemplary scenario 80 neither directly instantiates the objects nor requests the generating of a factory method.

The reflection programming interface 66 in this exemplary scenario 80 includes two components: a factory method generating component 96 configured to generate methods at runtime that in turn generate objects based on a particular object definition, and a factory method invoking component 98 configured to invoke a factory method to compose such an object. Upon receiving the first object composing request 88, the reflection method 92 searches the memory 52 of the computer system to locate a factory method for composing objects based on the provided object definition 86. Upon failing to find such a factory method (since the source code 82 has not previously requested the composing of an object of this type), the reflection method 92 invokes the factory method generating component 96, which generates a factory method 100 corresponding to the object definition 86 and stores it in memory 52. (This factory method 100 does not rely back on the reflection programming interface 66 to compose the object, but rather interacts directly with memory 52 in a protected manner. The factory method 100 may therefore entail a higher level of security, such as greater freedom to access memory 52, but such security may be extended to the factory method 100 as it is generated automatically by a trusted process.)

Upon completing the generating of the factory method 100, the reflection method 92 invokes the factory method invoking component 98, which in turn retrieves the factory method 100 and invokes it to compose the fourth vehicle object 102, which is returned to the host environment 50 for further processing of the executable application 48. For example, the factory method 100 may compose the object as an instance of the Helicopter subclass of the Vehicle class, and may set one or more fields of the object to particular values (e.g., by setting the field representing the number of wheels of the vehicle to zero.) The host environment 50 issues a second object composing request 90 for composing the fifth vehicle object 104. The reflection method 92 again searches memory 52 for a corresponding factory method, and this time the reflection method 92 locates the factory method 100 for generating helicopter-type objects based on the object definition 86. The reflection method 92 therefore invokes the factory method invoking component 98 to invoke the factory method 100, which generates the fifth vehicle object 104 and returns it to the host environment 50 for further processing.

The exemplary scenario 80 illustrated in FIG. 4 exhibits at least two advantages over the exemplary scenario 60 of FIG. 3. First, the single invocation of the reflection programming interface 66 for composing each object consolidates the evaluation of security safeguards for the composing of the object, in contrast with a repeated invocation of the reflection programming interface 66 to generate the third vehicle object 70 in a sequential manner that involves a potentially redundant evaluation of similar safeguards. Second, the second invocation of the reflection programming interface 66 in FIG. 4 reuses the verifiably safe factory method 100 previously generated during the composing of the fourth vehicle object 102, thereby avoiding all such safeguards for subsequent invocations. The performance improvements and economization of system resources arising from the use of this alternative technique may be substantial, particularly where the object definition 86 includes many members (which would otherwise entail many sequential invocations of the reflection programming interface 66), and/or where a large number of objects are composed from an object definition 86 provided at runtime.

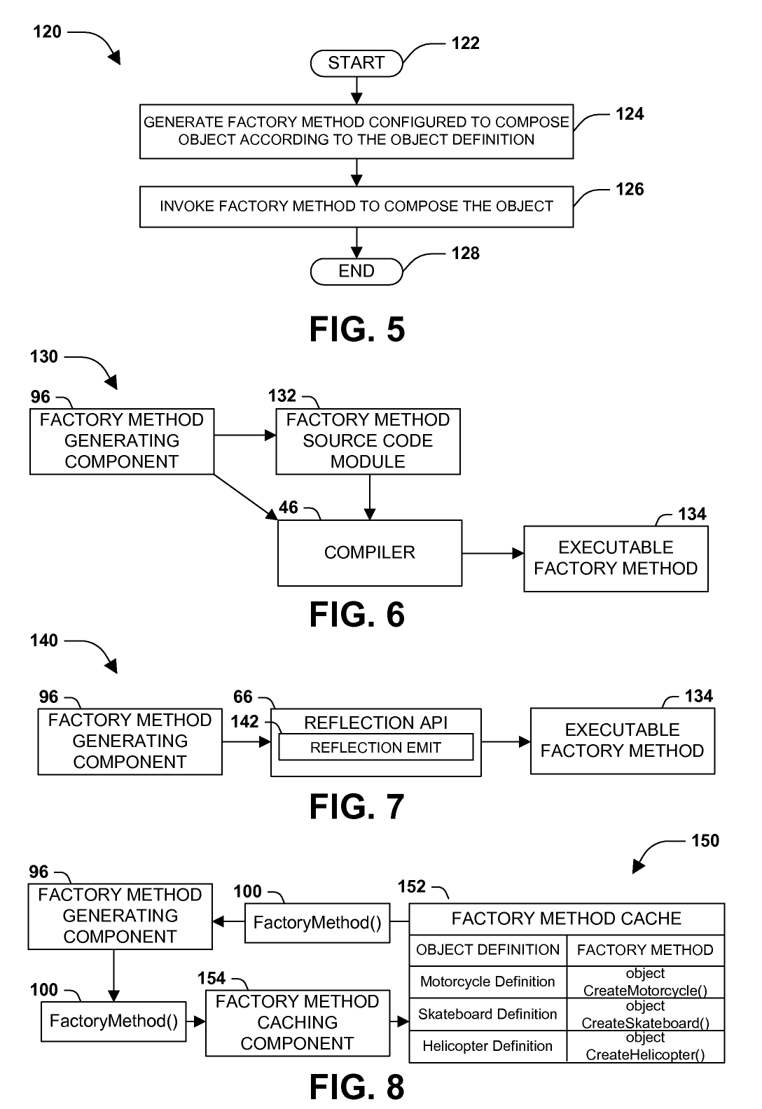

FIG. 5 illustrates a second exemplary embodiment of the techniques, comprising a computer-implemented method 120 of composing an object at runtime according to an object definition. The exemplary method 120 begins at 122 and involves generating 124 a factory method configured to compose the object according to the object definition. The exemplary method 120 also involves invoking 126 the factory method to compose the object. By automatically generating the factory method and invoking it to compose the object, the exemplary method 120 thereby achieves the composing of the object, and so ends at 128.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary system 94 of FIG. 4 and the exemplary method 120 of FIG. 5) to confer individual and/or synergistic advantages upon such embodiments.

A first aspect that may vary among implementations of these techniques relates to the scenarios in which the techniques may be applied. As a first example, many programming language include logical constructs that are similar to classes and objects. While object-oriented programming languages may be particularly suitable, these techniques may be similarly applied in programming languages organized around other paradigms, such as functional programming languages. These techniques may also be utilized in non-imperative programming languages, such as declarative programming languages (e.g., a Document Object Model dataset, such as an XML document, may call for the generation of a new element with particular properties, and a parser utilizing the dataset may automatically prepare and invoke a factory method that generates the object.)

As a second example of this first aspect, the elements of the techniques discussed herein (such as the components of the exemplary system 94 of FIG. 4) may be factored in many ways. For example, the factory method invoking component 98 may comprise a sophisticated module that retrieves the factory method 100, prepares a request to instantiate an object, further instantiates the object generated by the factory method 100 (e.g., by invoking a constructor method), and mediates its return to the hosting environment 50 (e.g., via SOAP exchange over a network.) Alternatively, the factory method invoking component 98 may comprise a simple component, and perhaps even a single instruction, that invokes the factory method 100 for the object definition 86 and returns the composed object to the hosting environment 50. The retrieval of the factory method 100 from memory 52 may also be performed either by the factory method generating component 96 or by the factory method invoking component 98. As a third example, the components may be organized within the computer system in many ways. For example, as illustrated in FIG. 4, an embodiment of these techniques may be included with a set of object composing tools, such as a reflection programming interface 66, that the host environment 50 may access on behalf of an application. Alternatively, an object definition 86 may be specified in an application managed by a runtime component (such as a host environment 50), which may comprise the factory method generating component 96 and the factory method invoking component 98. Those of ordinary skill in the art may devise many scenarios in which the techniques discussed herein may be utilized.

A second aspect that may vary among embodiments of these techniques relates to the nature of the object definition 86 on which objects may be composed at runtime. As a first example, the object definition 86 may comprise many types of object-defining datasets, such as an object existing in the host environment 50, a dataset provided to the executable application 48 at runtime (e.g., an XML document specifying the composition of objects of a particular type), a record in an object schema database, etc. As a second example, the object definition 86 may be partly or wholly specified by a user, who may identify particular fields to be set to particular values, and/or by another process, which may generate an object definition 86 and provide it to the executable application 48 and/or the host environment 50. As a third example, the object definition 86 may include many types of information that define the composition of the object, such as (e.g.) constants, primitive data types, constructor methods and other invokable methods, interfaces, and events. Those of ordinary skill in the art may devise many forms of object definitions 86 and objects instantiated thereby that may be used to generate objects at runtime according to the techniques discussed herein.

A third aspect that may vary among embodiments of these techniques relates to the manner of generating the factory method 100. As a first example, the factory method 100 may be generated (e.g., by a factory method generating component 96) by generating and compiling source code comprising the factory method 100. FIG. 6 illustrates an exemplary scenario 130 involving this technique for generating the factory method 100, wherein the factory method generating component 96 first generates a source code module 132 that comprises the factory method 100 configured to compose the object according to the object definition 86. The factory method generating component 96 then invokes the compiler 46 to at least partially compile the source code module 132, thereby producing an executable factory method 134. Alternatively, the factory method may be generated more directly through a reflection emit technique, which enables a process at runtime to emit a series of instructions that comprise a new method. FIG. 7 illustrates an alternative exemplary scenario 140 for generating the factory method 100, wherein the factory method generating component 96 invokes a reflection emit method 144 of the reflection programming interface 66 to request the emitting of a new method comprising a set of instructions that are configured to compose the object according to the object definition 86. The reflection emit method 142 then emits at least one partially compiled instruction, thereby generating the executable factory method 134.

A second example of this third aspect that may further improve the performance of these techniques involves the caching of the factory method 100 for use in composing additional objects according to the object definition 86. For example, the computer system may comprise a factory method cache 152 that is configured to store object definitions 86 associated with factory methods 100 (which may be wholly or partially compiled, etc.) Upon receiving an object definition 86 for an object to be composed at runtime, the factory method generating component 96 may first search the factory method cache 152 for a cached object definition that matches the object definition 86, which may indicate that a factory method 100 for this object definition 86 has already been generated. Upon failing to find a cached object definition matching the object definition 86, the factory method generating component 96 may generate the factory method 100, and may then provide the object definition 86 and the generated factory method 100 to a factory method caching component 154, which may store the object definition 86 and the factory method 100 in the factory method cache 152 and associate the factory method 100 with the cached object definition. However, upon finding a cached object definition matching the object definition 86 in the factory method cache 152, the factory method generating component 96 may retrieve from the factory method cache 152 the factory method associated with the cached object definition. In this manner, the factory method generating component 96 may rely on a caching of the factory method 100 to improve the performance and economize system resources that might be inefficiently spent redundantly generating many factory methods (and evaluating the safeguards related thereto) for the same object definition 86. Those of ordinary skill in the art may devise many ways of generating factory methods 100 while implementing the techniques discussed herein.

A fourth aspect that may vary among embodiments of these techniques relates to the manner of composing objects with a generated factory method 100. Invoking the factory method 100 may produce the representation of the object in memory 52, with member methods associated with compiled methods also stored in memory 52, and with member primitive types initialized to default values, etc. However, additional processing may be automatically applied to the object during object composing, e.g., as a convenience to a developer who is alleviated from further configuring the object. Such additional processing may be applied by the factory method (e.g., by generating a factory method configured to implement such features), or during the object composing (e.g., by the factory method invoking component 98.)

As a first example of this fourth aspect, if the composed object includes a constructor method, the composing may include invoking the constructor method to further initialize the members of the object. As a second example, the object definition may specify a base class from which the object is derived (e.g., the Vehicle class 14 from which the various objects, such as the Motorcycle object, the Skateboard object, and the Helicopter objects, are derived in the exemplary scenarios of FIGS. 2-4.) In these cases, the composing may involve composing an instance of the base class (and possibly invoking a constructor method of the base class), followed by supplementing the instance of the base class according to the object definition 86. As a third example, the object definition may specify at least one contained object as a member of the object (e.g., the Color object contained in the objects composed in the examples of FIGS. 2-4.) In these cases, the composing may involve composing the at least one contained object and adding the at least one contained object to the object (e.g., by instantiating a new instance of the Color class, setting its value to an appropriate color, and adding it to a composed object deriving from the Vehicle class.) As a fourth example, the object definition may comprise at least one event handler method that is provided to handle occasions of one or more events arising within the computing environment. In this case, the composing may involve subscribing the event handler methods to the events as a “wire-up” step. Those of ordinary skill in the art may devise many additional features that may supplement the composing of objects according to the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

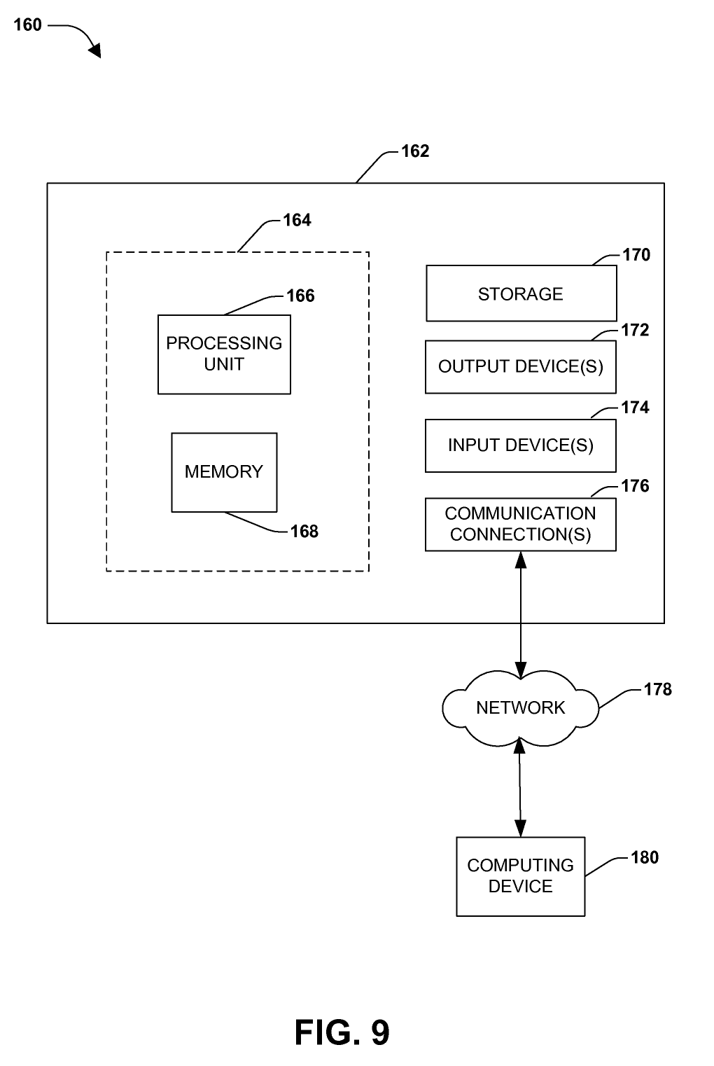

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 9 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 9 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-implemented method of composing an object at runtime according to an object definition, the method comprising:
generating a factory method configured to compose the object according to the object definition, and
invoking the factory method to compose the object.

2. The method of claim 1:
the object definition specified in an application managed by a runtime component, and
the method invoked at runtime by the runtime component.

3. The method of claim 1, the object definition specifying at least one of:
at least one constant,
at least one primitive data type,
at least one constructor method,
at least one invokable method,
at least one interface, and
at least one event.

4. The method of claim 1:
the object definition including at least one constructor method, and
the factory method configured to invoke the constructor method.

5. The method of claim 1:
the object definition specifying a base class from which the object is derived, and
the factory method configured to:
compose an instance of the base class, and
supplement the instance of the base class according to the object definition.

6. The method of claim 1:
the object definition specifying at least one contained object, and
the factory method configured to:
compose the at least one contained object, and
add the at least one contained object to the object.

7. The method of claim 1:
the object definition comprising at least one event handler method of the object to handle at least one event, and
the factory method configured, after invoking the factory method to compose the object, to subscribe the at least one event handler method to the at least one event.

8. The method of claim 1, the generating comprising:
generating a source code module comprising a factory method configured to compose the object according to the object definition, and
invoking a compiler to at least partially compile the source code module.

9. The method of claim 1, the generating comprising: emitting at least one at least partially compiled instruction configured to compose the object according to the object definition.

10. The method of claim 1:
the method comprising: upon generating the factory method, storing the object definition associated with the factory method in a factory method cache; and
the generating comprising:
searching the factory method cache for a cached object definition matching the object definition; and
upon finding a cached object definition matching the object definition in the factory method cache, retrieving from the factory method cache the factory method associated with the cached object definition.

11. A system configured to composing an object at runtime according to an object definition, the system comprising:
a factory method generating component configured to generate a factory method configured to compose the object according to the object definition, and
a factory method invoking component configured to invoke the factory method to compose the object.

12. The system of claim 11:
the object definition specified in an application managed by a runtime component, and
the runtime component comprising the factory method generating component and the factory method configuring component.

13. The system of claim 11:
the object definition specifying at least one constructor method, and
the factory method generating component configured to generate a factory method configured to invoke the constructor method.

14. The system of claim 11:
the object definition specifying a base class from which the object is derived, and
the factory method generating component configured to generate a factory method configured to:
compose an instance of the base class, and
supplement the instance of the base class according to the object definition.

15. The system of claim 1 1:
the object definition specifying at least one contained object, and
the factory method generating component configured to generate a factory method configured to:
compose the at least one contained object, and
add the at least one contained object to the object.

16. The system of claim 11:
the object definition comprising at least one event handler method of the object to handle at least one event, and
the factory method generating component configured to generate a factory method configured to subscribe the at least one event handler method to the at least one event.

17. The system of claim 11, the factory method generating component configured to
generate a source code module comprising a factory method configured to compose the object according to the object definition, and
invoke a compiler to at least partially compile the source code module.

18. The system of claim 11, the factory method generating component configured to emit at least one at least partially compiled instruction configured to compose the object according to the object definition.

19. The system of claim 11:
the system comprising:
a factory method cache configured to store an object definition associated with a factory method, and
a factory method caching component configured to store the object definition in the factory method cache with the factory method; and
the factory method generating component configured to:
search the factory method cache for a cached object definition matching the object definition; and
upon finding a cached object definition matching the object definition in the factory method cache, retrieve from the factory method: cache the factory method associated with the cached object definition.

20. A computer-implemented method invoked at runtime by a runtime component to compose an object according to an object definition specified in an application managed by the runtime component, the runtime component further comprising a factory method cache configured to store an object definition associated with a factory method, and the method comprising:
searching the factory method cache for a cached object definition matching the object definition;
upon finding a cached object definition matching the object definition in the factory method cache, retrieving from the factory method cache the factory method associated with the cached object definition;
upon failing to find a cached object definition matching the object definition in the factory method cache:
generating a factory method comprising a set of at least partially compiled instructions configured to compose the object according to the object definition, and
storing the object definition with the factory method in a factory method cache;
invoking the factory method to compose the object; and
subscribing at least zero event handler methods of the object to at least zero events according to the object definition.
